(19) United States
(12) Patent Application Publication
(10) Pub. No.: US 2009/0249071 A1
(43) Pub. Date: Oct. 1, 2009

(54) MANAGING CODE ENTITLEMENTS FOR SOFTWARE DEVELOPERS IN SECURE OPERATING ENVIRONMENTS

(75) Inventors: Dallas De Atley, San Francisco, CA (US); Heiko Panther, San Francisco, CA (US); Mitchell Adler, Cupertino, CA (US); Simon Cooper, Cupertino, CA (US); Michael Brouwer, San Jose, CA (US); Matt Reda, San Jose, CA (US)

Correspondence Address: Knobbe, Martens, Olson & Bear, LLP, 2040 Main Street, Fourteenth Floor, Irvine, CA, 92614, US

(73) Assignee: APPLE INC., Cupertino, CA (US)

(21) Appl. No.: 12/397,757

(22) Filed: Mar. 4, 2009

Related U.S. Application Data
(60) Provisional application No. 61/033,736, filed on Mar. 4, 2008.

(51) Int. Cl. H04L 9/32

(52) U.S. Cl. 713/171; 713/176

(57) ABSTRACT

Systems and methods for managing access to restricted data and system resources in secure operating environments are disclosed. Developer access profiles are issued by trusted authorities to developers which define entitlements that provide limited access to system resources and data on specified computing devices. The developer access profiles allow software developers to write software which accesses parts of the target platform environment which are typically off limits to third party developers.

### CROSS REFERENCE TO RELATED APPLICATIONS

This application claims the benefit of U.S. Provisional Patent Application No. 61/033,736, filed on Mar. 4, 2008, which is hereby incorporated by reference in its entirety.

### BACKGROUND

1. Field

This application relates to security in development environments.

2. Description of the Related Technology

Currently, computer systems may be configured to require that code executed on the computer system be authorized by a trusted party, such as the computer system's manufacturer. These types of requirements are typically implemented in order to ensure that the integrity of the computing device may be not compromised by malicious or unauthorized code. In some cases, computer systems may be configured to require that code be digitally signed by the trusted party and verified before being allowed to execute on the computing device. Verification of the digital signature ensures that the underlying application code has not been modified since it was digitally signed by the trusted authority.

However, this security scheme presents a challenge to a software developer. During development, a software developer will frequently modify their code on a computer system and may attempt to test it on that system. Each time the code may be modified, the digital signature becomes invalid. Therefore, in order to execute any new or modified code, the software developer must have that code signed again by the trusted authority. This process can be cumbersome and time consuming.

Previously, some manufacturers have issued development certificates that allow a software developer to digitally sign their code. However, simply allowing software developers to sign their own code fails to address other security issues on a device. For example, it may be desirable to give some developers different privileges and entitlements to a device depending on the software they are developing, their relationship with the manufacturer, etc. Conventional devices merely have generic or gross scale security policies that cannot be specialized for a particular device or a particular developer. In some circumstances, this may expose various security weaknesses or introduce errors.

### BRIEF DESCRIPTION OF THE DRAWINGS

FIG. 1 is a block diagram providing an example of a computing environment suitable for the distribution of software code to computing devices.

FIG. 2 is a block diagram providing one example of how a developer computing device from FIG. 1 may be configured to utilize developer access profiles.

FIG. 3 is a more detailed view of the developer access profile shown in FIG. 2.

FIG. 4 is a more detailed view of the developer identifier data shown in FIG. 3.

FIG. 5 is more detailed view of the device identifier data shown in FIG. 3.

FIG. 6 is a more detailed view of showing examples of the entitlement data from FIG. 3.

FIG. 7 is a flowchart which provides an illustration of how a computing device may be configured to verify and authenticate software.

FIG. 8 is a flowchart illustrating a general process by which third party software developers may be granted developer access using developer access profiles.

FIG. 9 is a flowchart providing an alternative example of how a developer computing device may utilize a developer access profile to execute code.

FIG. 10 is a flowchart which provides an example of how entitlement data from FIG. 6 may be requested, generated, and delivered to software developers.

FIG. 11 is a flowchart providing an example of applying entitlements to software code on a computing device.

FIG. 12 is a flowchart providing an example of how entitlements are used to determine whether code may be executed on a device.

FIG. 13 is a flowchart providing an example of how the policy service may be configured to reduce encryption/decryption operations in a computing device.

FIG. 14A illustrates an example mobile device.

FIG. 14B illustrates another example of configurable top-level graphical user interface of a device.

FIG. 15 is a block diagram of an example implementation of a mobile device.

### DETAILED DESCRIPTION

Embodiments are disclosed herein that allow for fine-grained control of entitlements granted to a software developer, when that developer has been granted development access to a device. In particular, embodiments provide a developer access profile that can specify a policy or list of entitlements. This developer access profile may be specific to a particular developer and a specific set of devices. Accordingly, when the software developer is executing their code, even though they may have enhanced access to the device, the developer access profile manages how their code can be executed.

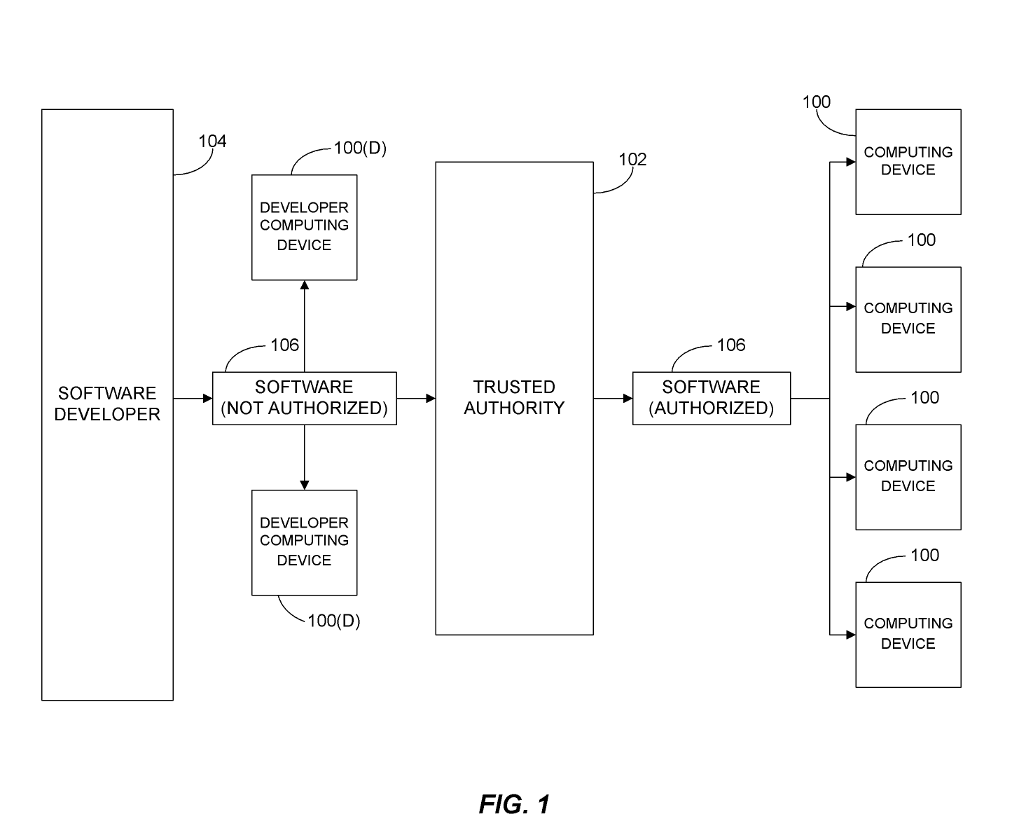

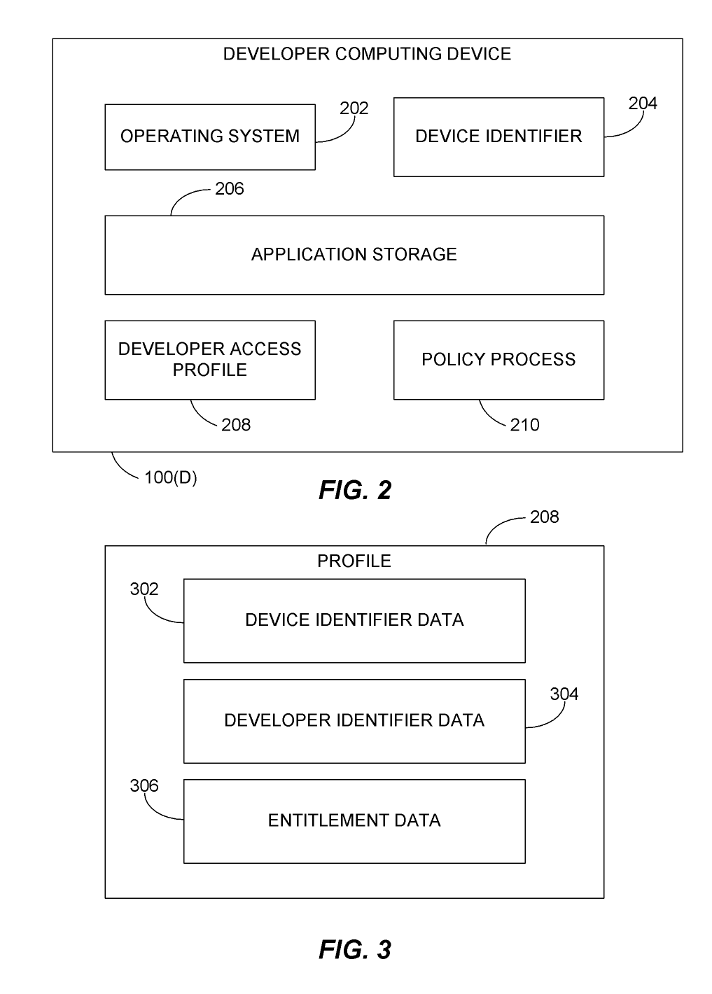

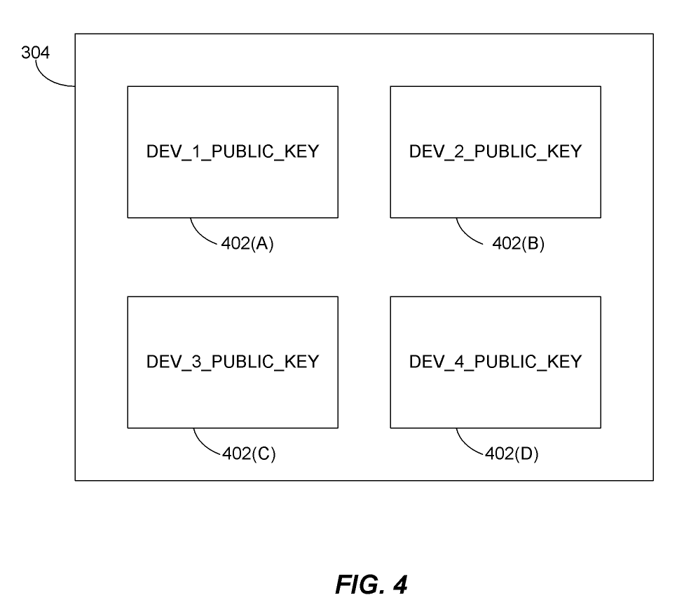

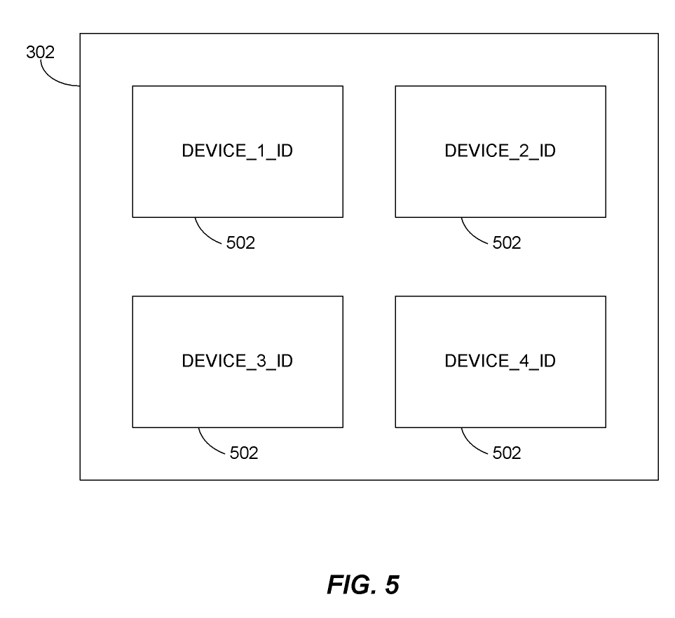

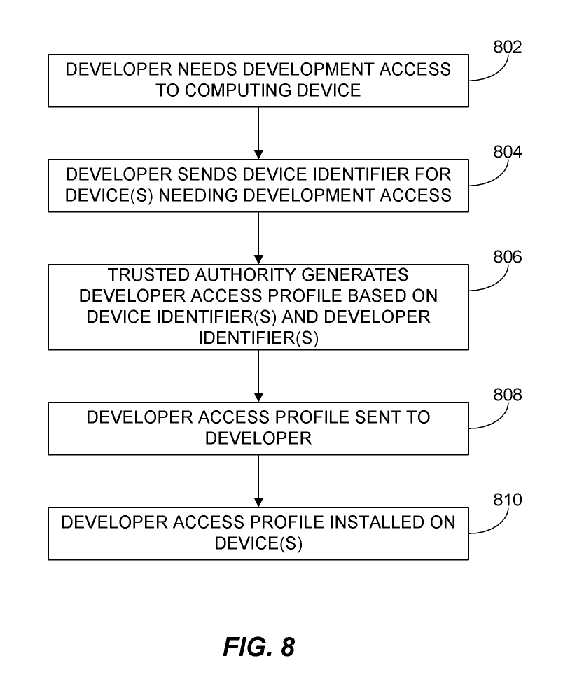

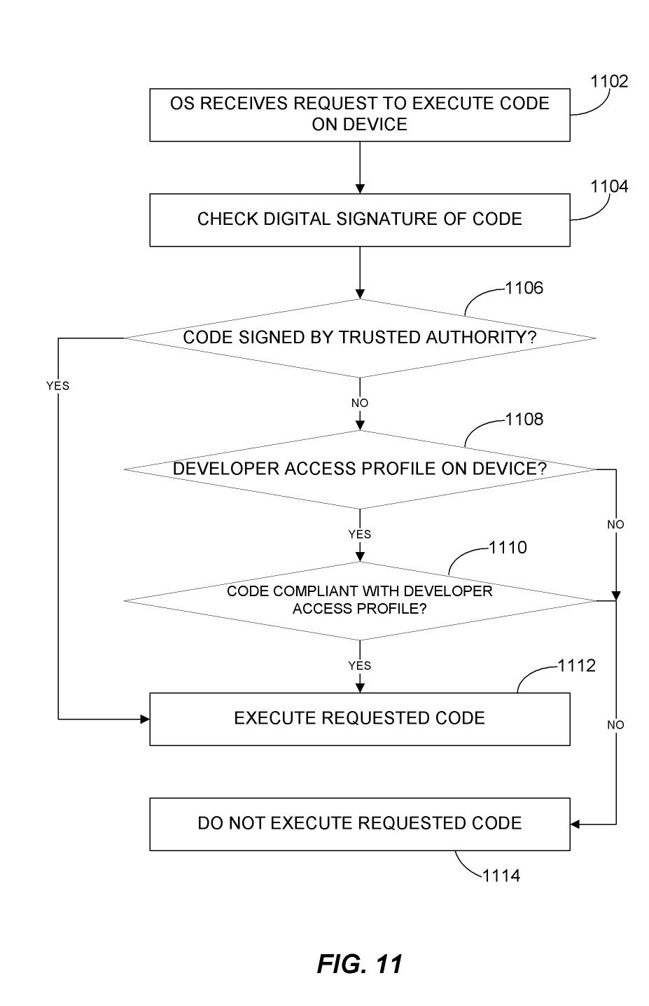

In order to illustrate embodiments of the present invention, FIGS. 1-13 will now be presented below. FIG. 1 may be an overview of how software for computing devices can be developed on a developer computing device and eventually distributed. FIGS. 2-3 illustrate further detail of a developer computing device and a developer access profile. FIGS. 4-6 illustrate various components of the developer access profile, which may comprise one or more public keys of the developer, one or more device identifiers, and a set of entitlements that have been assigned to the developer. FIGS. 7-9 are provided to illustrate various process flows that are related to obtaining developer access profile and how code or applications on a developer computing device can be executed based on the developer's profile and signature. FIGS. 10-13 are then provided to illustrate how the entitlement data is generated, delivered and enforced. Reference will now be made to FIG. 1.

FIG. 1 may be one example of a computing environment, which allows for the distribution of authorized software code to computing devices that are configured to execute only authorized code. As shown, the computing environment may include a set of computing devices 100, a trusted authority 102, and a software developer 104. These entities will now be further described.

Computing devices 100 may be any number of different types of computing devices, including desktop computers, laptop computers, handheld computers, personal digital assistant (PDA) devices, mobile telephone devices media player devices, and the like. For example, in some embodiments, computing devices may be an iPhone™, iPod™, or other device from Apple Computer Inc. Computing devices 100 may be configured to require that some or all of the code be authorized by trusted authority 102.

For example, an operating system of computing device 100 may be configured to verify that all code has been authorized by trusted authority 102. For example, operating systems, such as MacOS, Windows, Linux, Unix, and Symbian, can be configured to control execution of a code or applications based on whether it has been signed by an authorized entity. If the code is authorized and verified, it may be generally executed without any further system or user interaction; if the code has not been authorized, its ability to be executed on computing device 100 may be restricted. In some embodiments, the computing device may alert the user that the code may be not authorized and ask the user if they still wish to execute the unauthorized code. In other embodiments, computing devices 100 may be configured to prevent unauthorized code from being executed at all, regardless of the user's preference.

In some embodiments, trusted authority 102 may be any entity that has the authority to determine whether software, such as software 106, can be executed on computing devices 100. For example, trusted authority 102 may indicate its authorization of software by digitally signing it. As may be known in the art, a digital signature uses public key cryptography to help ensure the integrity of data. A digital signature can be used to identify the source of the data, and can be further used to detect any modifications to the data subsequent to the application of the digital signature.

Although FIG. 1 shows a single trusted authority 102, embodiments of the present invention may employ any number of trusted authorities alone or in combination. For example, each of several trusted authorities may have the unilateral authority to allow code to be executed on computing devices 100. As another example, authorization from a combination of trusted authorities, such as both a manufacturer and an operating system provider, can be required.

Software developer 104 may be any entity that develops, distributes, tests, installs, etc. applications and code on computing devices 100. In order to distribute its code to computing devices 100, software developer 104 may provide trusted authority 102 with compiled object code in the form that it may be intended for distribution to computing devices 100. During deployment of software from developer 104, trusted authority 102 may digitally sign the object code of the software 106, and can then make the code available to computing devices 100 with its digital signature. Subsequently, when a request to execute the software is made on computing device 100, computing device 100 can check the digital signature of the software 106 to verify its authenticity and/or authorization. If the software can be verified as being signed by trusted authority 102, software 106 is allowed to execute on computing device 100. There are various well known ways for computing device 100 to check the digital signature of the software 106 prior to execution.

In order to develop software, software developer 104 may coordinate with trusted authority 102 to obtain access to one or more of computing devices 100 that allows it to develop software. Because software developer 104 may wish to test its software on deployed computing devices 100, software developer 104 may obtain or purchase computing devices 100.

However, during the software development process, the code in a software application may change frequently. In order to alleviate the need for trusted authority 102 to digitally sign code repeatedly, trusted authority 102 may instead provide a digital certificate and a developer access profile, which may be installed on computing devices 100(D). With the digital certificate and access profile installed, computing devices 100(D) may thus be converted into developer computing devices.

The developer access profile may allow software developer 104 to modify, recompile, and test their software on these developer computing devices 100(D) without the need to request additional code signing services from trusted authority 102. In particular, a developer access profile may be installed on developer computing devices 100(D), which configures it to accept digital signatures from software developer 104 and execute code signed by software developer 104. In some embodiments, developer computing devices 100(D) may also, in addition to receiving developer access profiles, include development and test related software such as a debugging, tracing, or profiling software as part of a standard distribution installed on developer computing devices 100, as part of a pre-provisioning process, or at any other time. In some embodiments, developer computing devices 100(D) are pre-provisioned with such additional development related software. In other embodiments, development related software may be installed on the device with, or in conjunction with, the developer access profile. Further details of one embodiment of such a developer access profile and how it may be implemented on developer computing device 100(D) will now be described with reference to FIGS. 2 and 3 below.

FIG. 2 shows a block diagram providing one example of how the developer computing device 100(D) may be configured to utilize developer access profiles to execute software signed by software developer 104. As noted above, developer computer device 100(D) may be the same type of device as computing devices 100 for which the software 106 created by software developer 104 may be intended. For example, if the software 106 can be developed to run on a certain mobile phone platform, computing devices 100 and 100(D) may both operate on the same platform with the only difference being that the developer computing devices 100(D) are utilized by software developer 104 (for testing and quality assurance purposes, for example), whereas the other computing devices 100 are used by end users.

Developer computing device 100(D) may typically include an operating system 202. The operating system may be well-known operating system such as MacOS, Windows, Linux, Unix, Symbian, or the like. As discussed briefly above, operating system 202 may be configured to require that some or all code executed on the device 100(D) be authorized prior allowing it to be executed. In some embodiments, trusted authority 102 or software developer 104 may utilize a code signing certificate, which may be used to verify the source and integrity of the signed computer code.

The developer computing device 100(D) may also include a device identifier 204. The device identifier 204 may take various forms. In one embodiment, the device identifier may be a serial number that uniquely identifies the developer computing device 100(D). In other embodiments, the device identifier may be a unique identifier generated by the operating system 202.

Furthermore, the developer computing device 100(D) can include software storage 206. The software storage 206 may be a location on the device where software 106 may be stored for use by the operating system 202 of the device. The software storage 206 may take the form of volatile and/or non-volatile memory on the computing device. The software 106 may be stored temporarily in the device 100(D) or permanently in the device 100(D).

In some embodiments, on developer computing device 100(D), digital signatures can be created by performing a hash function on the software in order to create a message digest, which may then be signed using a private key of software developers 104 or trusted authority 102. A digital signature may include a digest that may be created, for example, by performing a hash function on the software in order to create a message digest. In some embodiments, incremental code signing may be used. The hash value may be a hash value generated for all or a particular portion of the software. For example, in some embodiments, the software is divided into one or more units such as one or more pages. A hash value is generated for each unit or page of the software. The digest for the software in such embodiments includes a hash value that is generated for an array or table of the hash values of each code or page. The message digest may be then encrypted using a private encryption key associated with trusted authority 102. In one embodiment, the well known SHA-1 function may be used to generate the message digest. The encrypted message digest (also referred to as the signature) may be then appended to the one or more of the software modules 206. Thus, when executing software code, the operating system 202 on developer computing device 100(D) may process the request by verifying the source and integrity of the software code by validating the digital signature was signed by either trusted authority 102 or software developers 104 using the public keys of trusted authority 102 or software developers 104.

In order to manage the developer access of software developer 104, developer computing device 100(D) may also have a developer access profile 208. Profile 208 may be created by trusted authority 102, which may then be installed on the developer computing devices 100(D). Developer access profile 208 can be a set of data that permits execution of software signed by entities other than trusted authority 102. In particular, developer access profile 208 can allow software developers 104 to modify and recompile source code for their software 106, and then test the software 106 on the developer computing device 100(D) without needing to request additional code signing services from trusted authority 102. Instead, software developer 104 may be permitted to digitally sign their software 106, and run the software on those developer computing devices 100(D) which have developer access profiles 208 that specify that code signed by the developer 104 may be executed on the device 100(D). In some embodiments developer access profile 208 may also specify certain operations that the developer 104 may perform in testing the software 106. For example, developer access profile 208 may specify that software 106 digitally signed by the developer 104 may be debugged on the developer computing devices 100(D) included in developer access profile 208. Developer computing device 100(D) may have more than one developer access profile 208 installed.

In some embodiments, developer access profile 208 may operate in conjunction with policy process 210. Policy process 210 may take the form of a daemon process that is trusted by operating system 202. Alternatively, policy process 210 may be a portion of the operating system kernel 202. For example, access profile 208 may be a file having attribute/value pairs that are read by policy process 210.

In some embodiments, policy process 210 may be installed on computing devices 100 along with developer access profile 208. Alternatively, policy process 210 may be included with the device when originally shipped. In still other implementations, policy process 210 may be added to the device via an operating system update process as may be known in the art.

Policy process 210 may be typically used to enforce policies specified in developer access profile 208. In certain embodiments, policy process 210 may be configured to detect code execution requests and determine whether the request should be permitted. For example, when a request to execute code is detected, policy process 210 may be configured to check the digital signature of the code to ensure that it is valid. If the digital signature is not from trusted authority 102, policy process 210 may access the developer identifier data 302 of developer access profile 208 on the device 100(D) to determine if the signature may be from any of software developers 104 authorized in the profile 208 to sign software 106.

In some embodiments, if developer access profile 208 specifies that a developer can trace the operation of the software on the development device but does not allow debugging, the policies process 210 will allow trace operations, but allow running applications in debug mode.

FIG. 3 shows a more detailed view of developer access profile 208. As noted above, developer access profile 208 may be a set of data stored on device 100(D). As shown, developer access profile 208 may include, among other things, device identifier data 302, developer identifier data 304, and entitlement data 306. These items will now be further described.

Device identifier data 302 specifies one or more device identifiers 204 to which developer access profile 208 apply. For example, in embodiments where the devices 100 are mobile telephone devices, device identifier data 302 may include an array of mobile telephone device serial numbers. Developer access profile 208 may further include developer identifier data 304, which specifies software developers 104 to whom developer access profile 208 applies.

Developer identifier data 304 may take various forms. In some embodiments, developer identifier data 304 may include a name or identifier of software developer 104 and one or more public keys associated with software developers 104 covered by developer access profile 208. Other types of information may also be used.

Entitlement data 306 may include data, which indicates the types of operations that are allowed for software 106 signed by developers 104. In general, entitlement data 306 may be highly granular and specify entitlements at a high level of specificity. In this manner, developer access profile 208 can be highly customized for each of software developers 104 and, if needed, for each of devices 100(D). FIGS. 4-6 will now be described to illustrate further detail regarding developer identifier data 304 and entitlement data 306.

FIG. 4 shows a more detailed block diagram of the developer identifier data 304. As discussed above, developer access profile 208 may specify more than one developer 104 as being authorized to digitally sign code. In the example provided in FIG. 4, four developer identifiers 402(A)-402(D) are specified, with four different public keys stored in the developer identifier data 304. In some embodiments, developer identifier data 304 may be stored in an array data structure stored within the developer access profile. Other types of data structures may also be used.

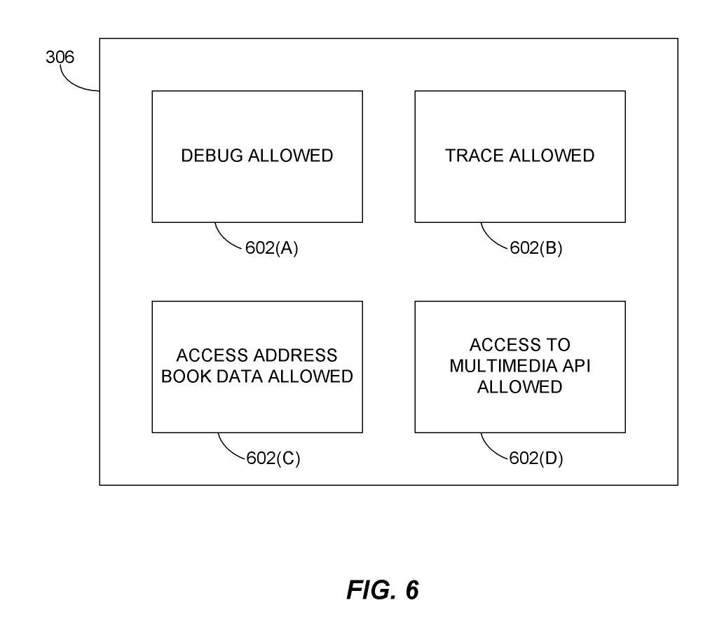

FIG. 5 shows a more detailed block diagram of the device identifier data 302. Device identifier data 302 for a developer access profile 208 may include one or more device identifiers 204. In the example provided in FIG. 5, four different device identifiers 204(A)-204(D) (which are related to four different developer devices 100(D)) are included in the profile 208. Although the example provided includes specific device identifiers, in some embodiments, more generalized device identifying data may be utilized. For example, some device vendors and/or manufacturers may provide devices having device identifiers which are specific to an organization. For example, a device vendor and/or manufacturer may customize certain aspects of device identifiers 204 associated with devices based on the organization to which they are delivered. In these instances, the device identifier data 302 may include ranges of device identifiers, rather than listing each individual device identifier value. In still other embodiments, wild card characters may be used to specify that the developer access profile applies to all devices having specified identifier characteristics. In still other embodiments, the device identifier data could specify developer access profile 208 applies to all devices. In these instances, software signed by one or more of the developers identified in developer identifier data 302 could be authorized to run on any device 100 upon which developer access profile 208 may be installed.

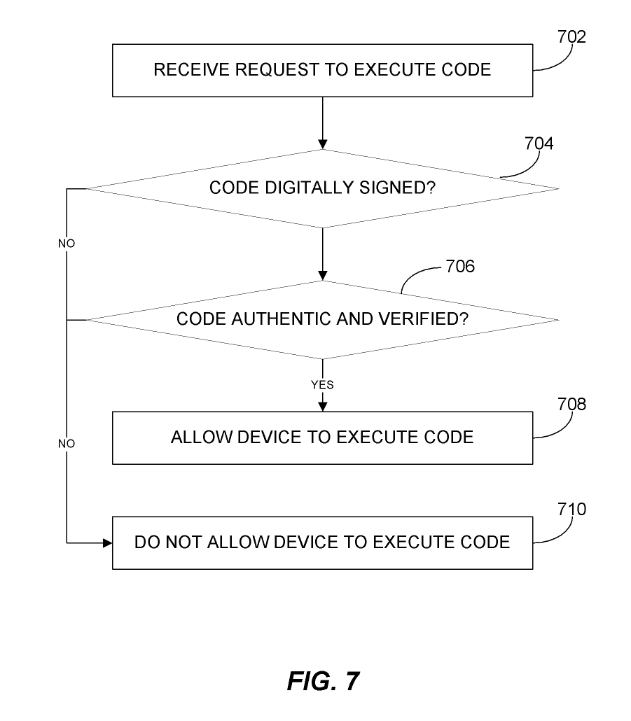

FIG. 6 provides a more detailed view of an example of the types of data that may be included in entitlement data 306. As discussed above, developer access profile 208 may specify the types of access that are permitted for applications signed by the developers 104. On developer computing device 100(D), software developers 104 may be required to be listed in developer identifier data 304 and may be limited to the entitlements described in entitlement data 306.

Entitlement data 306 may take the form of predefined Boolean variables which are indicative of various entitlements. The example provided in FIG. 6 shows four possible entitlements 602(A)-602(D).

If entitlement 602(A) is set to “TRUE”, code signed by developers 104 associated with developer access profile 208 are permitted to build their software 106 in a debug mode and then run the software 106 on the device 100(D) in a debug mode. If the debug mode allowed entitlement 602(A) is not set to “TRUE”, and the developer 104 attempts to run the software in debug mode on the device 100(D), policy process 210 may be configured to not allow the execution of the code.

Trace allowed entitlement 602(B) allows software 106 digitally signed by the developer 104 to be compiled and executed in trace mode on the devices 100(D) covered by developer access profile 208. Entitlement data 306 may further specify entitlements which relate to the degree and/or types of access that software 106 signed by the developer 104 may have to certain data stored in the file system on the device 100(D). In some embodiments, these areas may include data that is typically off limits to applications. For example, in a mobile phone device, the address book data may include sensitive data that would not ordinarily be accessible by a third party application program, access to network connectivity of a mobile phone device may also be restricted. However, if software developer 104 wishes to develop an application that needs access to the address book data, an access address book data entitlement 602(C) may be defined that allows this access.

Entitlement data 306 may also specify entitlements which relate to the degree and/or type of access to operating system application programming interfaces (APIs) that are available to the software 106. For example, software developer 104 may wish to write a software application that plays multimedia files on computing device 100(D) via calls to the multimedia API in the operating system. Operating system 202 on the device 100(D) may be configured to not expose the multimedia API to applications unless signed by trusted authority 102. In order to provide software developer 104 with an ability to test the software 106 on computing device 100(D), an access to multimedia API entitlement 602(D) may need to be provided, which exposes this API to the software 106.

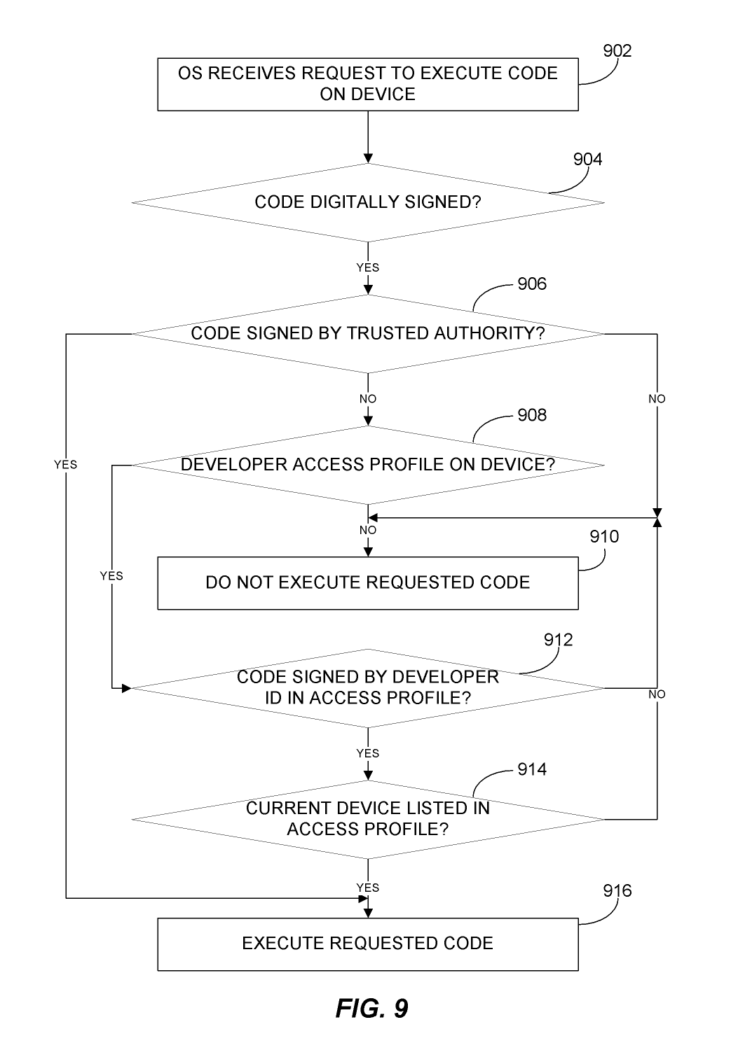

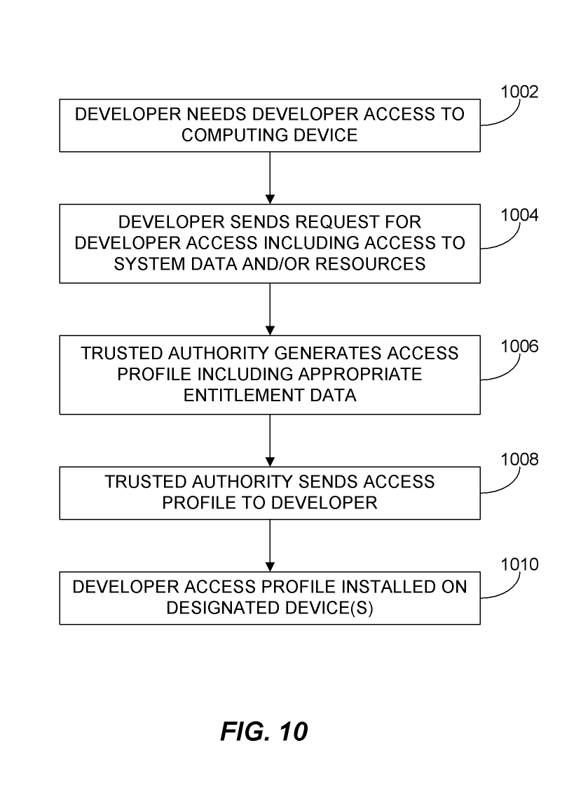

Various process flows for executing and developing code on computing device 100 will now be explained with reference to FIGS. 7-9. First, FIG. 7 is presented to illustrate how computing device 100 generally verifies software that it executes. FIG. 8 is then presented to illustrate the process of how software developer obtains developer access on a computing device. And finally, FIG. 9 illustrates a general process of how a software developer can develop and execute code on a computing device with their developer access. These figures will now be described.

As noted, FIG. 7 is a flowchart which provides an illustration of how a computing device 100 may be generally configured to verify software 106 prior to executing the software 106 on the device 100. The process begins at block 702 where a request to execute software code may be received at the device. Typically, this request may be received in the operating system 202, and the request includes a request to execute software code by a processor on computing device 100. The request may be generated by a user launching an application program that may be stored in the application storage 206 of the computing device.

The process then moves to decision block 704, where the computing device determines if the code has been digitally signed. If the code has not been digitally signed, the process moves to block 710 where the code may be not permitted to be executed on the device 100. If, however, the code may be digitally signed, the process moves to decision block 706, where the system authenticates and verifies the digital signature. In some embodiments, the verification and authentication may be provided by calculating a hash value (also called a message digest) for the digitally signed code and then decrypting the digital signature of the code using the public key of trusted authority 102 which purports to have signed the code. If the value of the message digest and the decrypted digital signature match, then the code may be verified and authenticated. If at decision block 706, the code is not authenticated and/or verified, the process moves to block 710 and the code execution may be not permitted on the device 100. If the code is authenticated and verified, the process instead moves to block 708, where the device 100 may be allowed, typically by the operating system, to execute the signed code.

FIG. 8 may be a flowchart illustrating the general process by which third party software developers (such as software developer 104) are granted developer access to developer computing devices 100(D) according to one or more embodiments described herein. The process may begin at block 802, where software developer 104 recognizes a need for development access to a computing device 100. As discussed above, in certain embodiments, the developer 104 writes software 106 intended to be executed on the device 100. Device 100 may, however, require that some or all code executed on the device be digitally signed.

Having recognized a need for developer access to the device 100, the process then moves to block 804, with developer 104 sending to trusted authority 102 a request for development access. In some embodiments, this request may include identifiers 204 of computing devices 100(D) for which the developer 104 desires developer access. As discussed above, the device identifiers 204 may take the form of device serial numbers or some other type of identifying data that may be specific to a particular device (or group of devices). In addition, software developer 104 may provide other information and data, such as identification of development personnel, an address, the types of access needed in their developer access, etc.

Next, at block 806, trusted authority 102 generates a developer access profile 208 based on the device identifiers 204 sent by software developer 104. In various embodiments, trusted authority 102 may implement one or more policies when generating developer access profile 208. These policies may vary based on several factors that, for example, may include: the type of software being developed by software developer 104; one or more other parties that are related to the computing devices 100, such as a telecommunications carrier or enterprise that owns computing devices 100; a geographic location of computing devices 100(D); hardware, software, or firmware versions installed on computing devices 100(D); and the like. In other words, developer access profile 208 may be highly specific to computing devices 100(D) and software developer 104.

In some embodiments, trusted authority 102 may also generate a developer identifier for software developer 104 making the request. This developer identifier may also be used for a digital certificate issued by trusted authority 102. In some embodiments, trusted authority 102 may be a certificate authority, or may utilize another entity as the certificate authority.

The digital certificate may include information about software developer 104 as well as a public key of software developer 104 that may be signed using the private key of trusted authority 102 or a certificate authority. The digital certificate may also include other information and data, such as a validity period for the digital certificate, one or more revocation authorities, etc.

As discussed above, a generated developer access profile 208 may include device identifier data 302 in the form of device identifiers 204 for those devices which are covered by developer access profile 208. The developer access profile also may include developer identifier data 304 as well as the digital certificate. Developer access profile 208 may also include various files and other information that indicates the specific privileges and entitlements that have been granted to software developer 104 on the specific devices identified. Once developer access profile 208 has been generated, it may be then sent by trusted authority 102 to software developer 104 at block 808.

For example, software developer 104 may obtain the digital certificate and developer access profile 208 by accessing a server over a network (such as a secure website on the Internet), via encrypted communications (such as email or file transfer), via an integrated development environment, or via delivery of a computer readable medium (such as disk, flash memory, or optical disk). In addition, software developer 104 may obtain the digital certificate and developer access profile together or separately.

Upon receiving developer access profile 208, software developer 104 may then store and install the digital certificate and developer access profile 208 on the devices 100(D) which are specified in the profile 208. For example, software developer 104 may employ an integrated developer environment application to install these items on computing devices 100(D). Alternatively, trusted authority 102 (or some other authorized entity) may install or push these items onto computing devices 100(D) on behalf of software developer 104. For example, software developer 104 may couple or connect computing devices 100(D) to a network or server. In response, after some preliminary authentication and other processing, the digital certificate and developer access profile 208 may be downloaded onto computing devices 100(D).

FIG. 9 may be a flowchart illustrating one example of how a developer computing device 100(D) handles executing digitally signed code according to developer access profile 208. The process may begin at block 902 where operating system 202 receives a request to execute code on developer computing device 100(D). Typically, this request may be generated by the user launching a software application. However it may also be a system process that it launched automatically without user input. Operating system 202 may be configured to check first if the code has been signed by trusted authority 102, and if not, check if the code is within development access.

In particular, when the request to execute code has been received by operating system 202, it may check if the code has been digitally signed at decision block 904. If the code has not digitally signed, the process may jump to block 910, and the code may be not permitted to execute on the device 100(D).

If the code has been digitally signed, the process then moves to decision block 906, where the system checks to determine whether the software code has been signed by a trusted authority 102 or software developer 104.

As discussed above, in some embodiments, the digital signature of the code may be authenticated and verified by decrypting the digital signature into a message digest using a public key associated with trusted authority 102 or software developer 104, and then validating the message digest against a message digest created by hashing the code itself. If the code has been verifiably signed by trusted authority 102 and has not been modified, in some instances, the process moves to block 916 and the code may be allowed to be executed.

If, however, at decision block 906 the code was not signed by trusted authority 102, the process may move to decision block 908 where the system then checks to determine whether a developer access profile 208 is present on the device 100(D). If no developer access profile 208 is present on the device 100(D), the process moves to block 910, and the requested code may be prevented from executing on the device 100(D).

If, however, a developer access profile 208 is present on the device, the process then moves to decision block 912. At decision block 912, the system checks the code to determine whether it has been signed by software developer 104 listed in developer access profile 208 on the device 100(D). If not, the execution process moves to block 910, and execution of the requested code is blocked.

If the code has been digitally signed by software developer 104 having at least one of developer identifiers 402, then the process may proceed to decision block 914. At block 914, operating system may check device access profile 208 to determine if the requested code execution is consistent with developer access profile 208. For example, operating system 202 may check whether device identifier 502 is listed in the device identifier data 302 of profile 208. Of course, other checks may be performed regarding the requested code execution, such as APIs called, and may be permitted or blocked based on developer access profile 208.

If device identifier 204 is not listed in profile 208, then processing may return to block 910 and the code execution may be blocked. If, however, the device identifier 204 is listed in developer access profile 208, then the process may move to block 916, where the execution of the requested code may be permitted.

FIG. 10 is a flowchart which illustrates an example of how entitlement data 602 in developer access profile 208 may be requested, generated, and delivered. Of note, this process may be performed in conjunction with the process flow described in FIG. 8, or may be performed as a separate process in addition to the process of FIG. 8. For example, software developer 104 may have previously received development access to other devices from trusted authority, but now wishes to update its access profile 208 or obtain new entitlements 602 for the same or different computing devices 100(D).

The process may begin at block 1002, where software developer 104 recognizes a need for enhanced access to one or more devices 100(D) in order to develop, test, and/or deploy their software 106. As noted above, this need may arise in various situations. For example, a developer may wish to write software 106 which utilizes system resources not typically exposed to developers 104. These system resources may include application programming interfaces (APIs) which are ordinarily made available only to applications signed by the trusted authority or running in a trusted memory space of the device.

One example of this type of access would be an application developer for a mobile telephone device wishing to develop a specialized telephony interface. Typically, these core functionalities of the telephone are not made available to those outside of trusted authority 102. However, for various reasons trusted authority 102 may wish to allow software developer 104 to develop such applications for a limited set of devices 100(D). As noted above, the system resources needed by developers 104 may also include access to specific data that is typically restricted by the operating system 202. Examples of this type of data include (but are not limited to) address book data, e-mail data stored in the device, call log data, and the like. In addition, software developer 104 may desire access to other resources of computing device 100(D), such as networking resources and certain memory resources.

The process then may move to block 1004, where software developer 104 may send a request for access to system data and/or system resources in certain devices 100(D). In some embodiments, the request sent by software developer 104 may list specific system resources and/or data to which access is needed. Alternatively, the request may simply specify the types of operations which are performed by their software 106. Based on the types of operations specified by software developer 104, trusted authority 102 may determine which entitlements 602 should be included in access profile 208.

In various embodiments, trusted authority 102 may implement one or more policies when generating entitlements 602 in developer access profile 208. These policies may vary based on several factors that, for example, may include: the type of software being developed by software developer 104; one or more other parties that are related to the computing devices 100, such as a telecommunications carrier or enterprise that owns computing devices 100; a geographic location of computing devices 100(D); hardware, software, or firmware versions installed on computing devices 100(D); and the like. In other words, developer access profile 208 may be highly specific to computing devices 100(D) and software developer 104.

Next, the process may move to block 1006 where developer access profile 208 is generated for software developer 104 to include entitlements 602. Access profile 208 may include entitlement data 306, which specifies entitlements 602 granted to code signed by software developer 104. As noted above, entitlements 602 may be white list entitlements, which specify affirmative entitlements, or they may be blacklist entitlements, which specify negative entitlements. In still other embodiments, entitlements 602 may be a combination of white lists and blacklists.

Once access profile 208 has been generated for software developer 104, the process then may move to block 1008, where trusted authority 102 may send access profile 208 to software developer 104. In some embodiments, access profile 208 may be transmitted via a network connection (e.g., over the Internet) which may be a secure network connection. Upon receiving access profile 208, software developer 104 may install it on devices 100(D). For example, software developer 104 may be executing an integrated development environment such as Xcode, on a system coupled to devices 100(D) and this environment may provide tools for installing access profile 208.

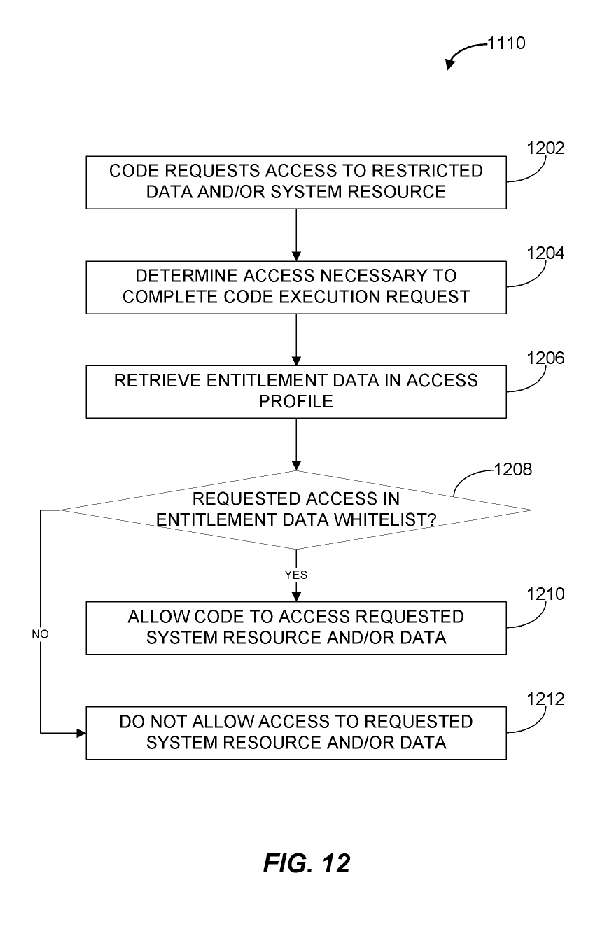

Moving now to FIG. 11, an example of a process by which computing device 100(D) applies entitlements 602 is provided. The process begins at block 1102, where operating system 202 of device 100(D) receives a request to execute code 106. Next, at block 1104, the digital signature of code 1104 is checked, and the process may move then to decision block 1106.

At decision block 1106, it is determined if the signed code was signed by trusted authority 102. If the signed code was signed by trusted authority 102, the process jumps to block 1112, where the device 100(D) is permitted by operating system 202 to execute the trusted signed code.

If the code is not found to be signed by trusted authority at block 1106, the process may move to decision block 1108, where it is determined whether developer access profile 208 is present on the device 100(D). In some embodiments, policy process 210 may be configured to perform this functionality. Alternatively, other parts of operating system 202 may make the determination.

If no developer access profile 208 is present on device 100(D), the process may move to block 1114, where the device is prevented from executing the requested code. If, however, a developer access profile 208 is found on the device 100(D), the process may then move to decision block 1110 where it is determined whether the code is compliant with entitlements 602 in developer access profile 208.

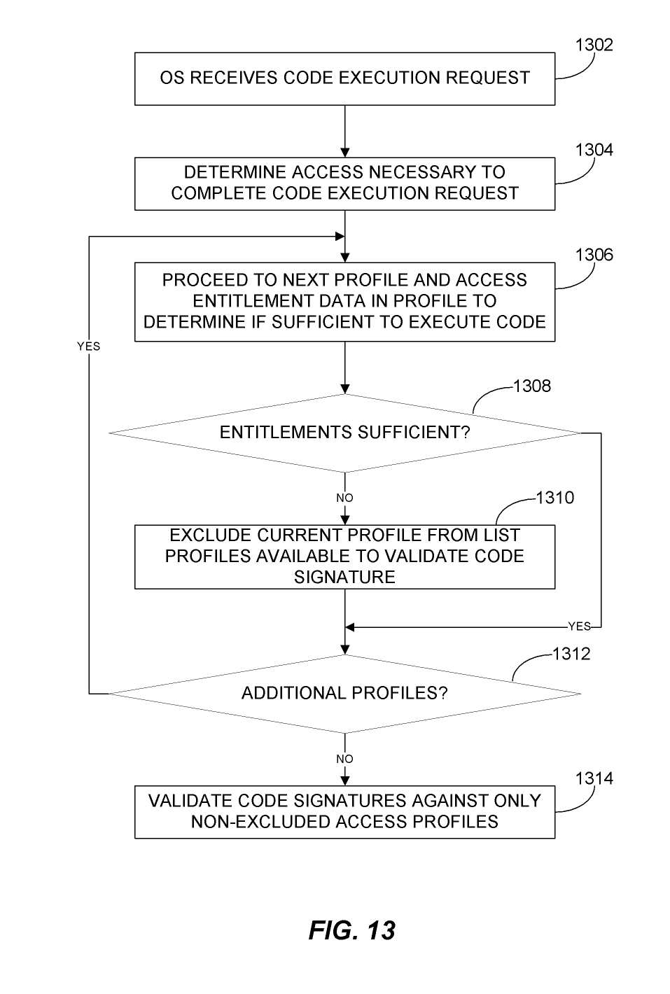

This determination may involve checking the code against entitlements 602 specified in entitlement data 306 of developer access profile 208. This determination may be performed by policy process 210. A more detailed example of how the code is check for compliance is provided with reference to FIG. 12 below.

If the code is found to be compliant with developer access profile at block 208, the process may move to block 1112, and the code is permitted to execute on the device. If sufficient entitlements are not present in access profile 208, however, the code executed may be halted on device 100(D). In some embodiments, a message may be displayed notifying the user that the application code has been restricted in some manner. In some embodiments, a specific error may be displayed to the developer or user which allows them to understand the type of access that is required for the application to have full functionality.

As noted above in connection with decision block 1110, policy process 210 may be configured to determine whether the entitlements 602 provided in developer access profile 208 on device 100(D) are sufficient to allow the code to access the system resources and/or data which called for upon execution of the code.

FIG. 12 is a flowchart providing one example of the how the code compliance determination from decision block 1110 may be performed. The process may begin at block 1202, where the code requests access to restricted data and/or system resources of computing device 100(D). As noted above, the restricted data and/or system resources may include address book data on a mobile telephone device, or it may include an API to the telephony functions in the mobile device, or it may include access to a network stack in the device.

Next, at block 1204, policy process 210 determines the types of access to data and/or system resources that are necessary to carryout the code request. The process then may move to block 1206, where policy process 210 retrieves the entitlements 602 from entitlement data 306 in developer access profile 208.

Once the type of access needed and the available entitlements have been determined, the process may move to decision block 1208, where policy service 210 determines whether the necessary access to system data and/or system resources is permitted by entitlement data 306. Typically, policy service 210 may check entitlements 602 to determine if the access needed to execute the code is included in the white list.

If the access is not specified in the white list, the process may move to block 1212, and the code is not permitted to access the requested data and/or system resources. However, if the entitlement data 306 includes entitlements 602 which permit the requested access, the process instead may move to block 1210, where the code is allowed to access the requested data and/or system resources.

In the process described above in connection with FIGS. 11 and 12, a single developer access profile 208 is assumed to be present on the device 100(D). However, as noted previously, it should be appreciated that a single device 100(D) may store any number of access profiles 208 which define different developer identifier data 302, device identifier data 304, and entitlement data 306. When software code 106 requests access to system data and/or resources, it is possible that any one of the many access profiles 208 may provide the necessary entitlements for the code execution to be permitted on the device 100(D). As noted previously, policy process 210 may access developer access profile 208 to verify the source and integrity of the signed code. This verification can be done by checking the digital signature against the public keys stored in access profile 208.

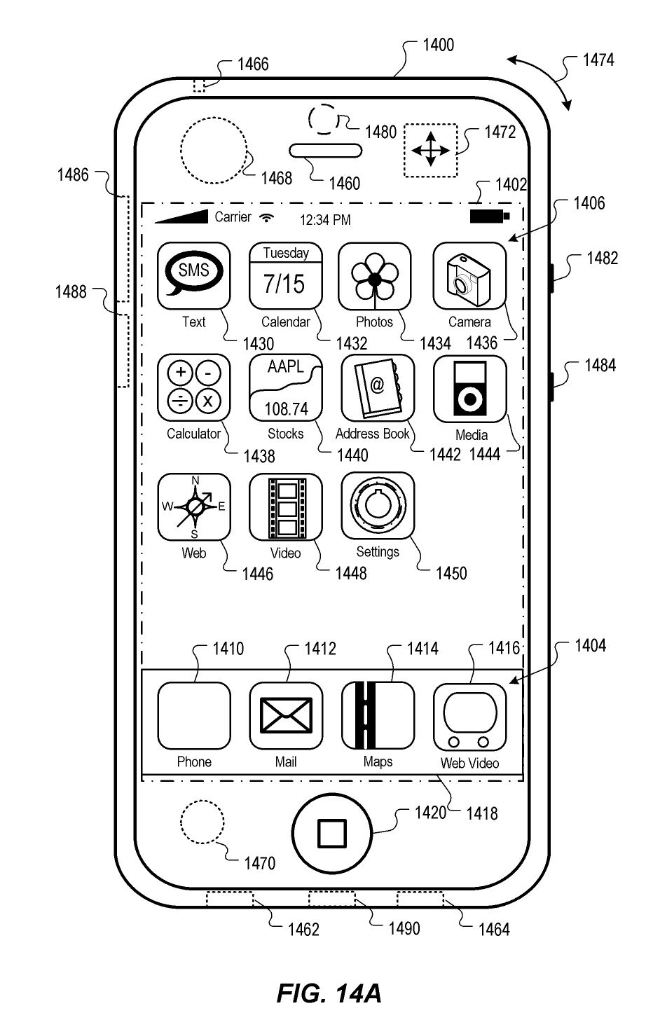

On devices which include many different profiles, this verification process may become computationally expensive where there are many potential public keys to check against the signed code. Accordingly, in some embodiments, policy process 210 may be configured to first analyze entitlements 602 that are needed to run the code properly, and then exclude those access profiles, which do not have the necessary entitlements prior to validating the signed code. This may result in a substantial performance benefit without compromising the security of the device. FIG. 13 is a flowchart providing an example of this process.

The process begins at block 1302 where the operating system 202 receives a request to execute software 106 on device 100(D). After receiving the request, policy process 210 or some other process may analyze the code to determine the access to data and/or system resources necessary to complete the code execution request on device 100(D) at block 1304. The process then may move to block 1306, where policy service 210 proceeds to the next access profile on the device 208 (in this initial case, the first access profile), and analyzes entitlements 602 specified in profile 208 to determine whether they are sufficient to allow the code to be executed on device 100(D).

The process then may move to decision block 1308, where the determination is made as to whether the entitlements 602 in the profile 208 are sufficient. If the entitlements are not sufficient to allow the code to be executed, the process may move to block 1310, and the current access profile 208 may be excluded from the list (or other grouping) of profiles available to validate the digital signature of the code.

Once an access profile has been excluded, the process then may move to decision block 1312, where the policy service checks to see if there are additional available access profiles 208. If so, the process returns to block 1306 and is repeated for that profile. If at decision block 1308, the entitlements 602 in the current profile 208 are found to be sufficient to allow the code to execute on the device 100(D), the process may move to decision block 1312 to check for additional profiles. If no additional profiles remain to check on the device, the process then may move to block 1314, where the digital signature of the code is validated against only the profiles 208 that were not previously excluded (at block 1310). Thus, a number of encryption/decryption and hashing operations may be significantly reduced.

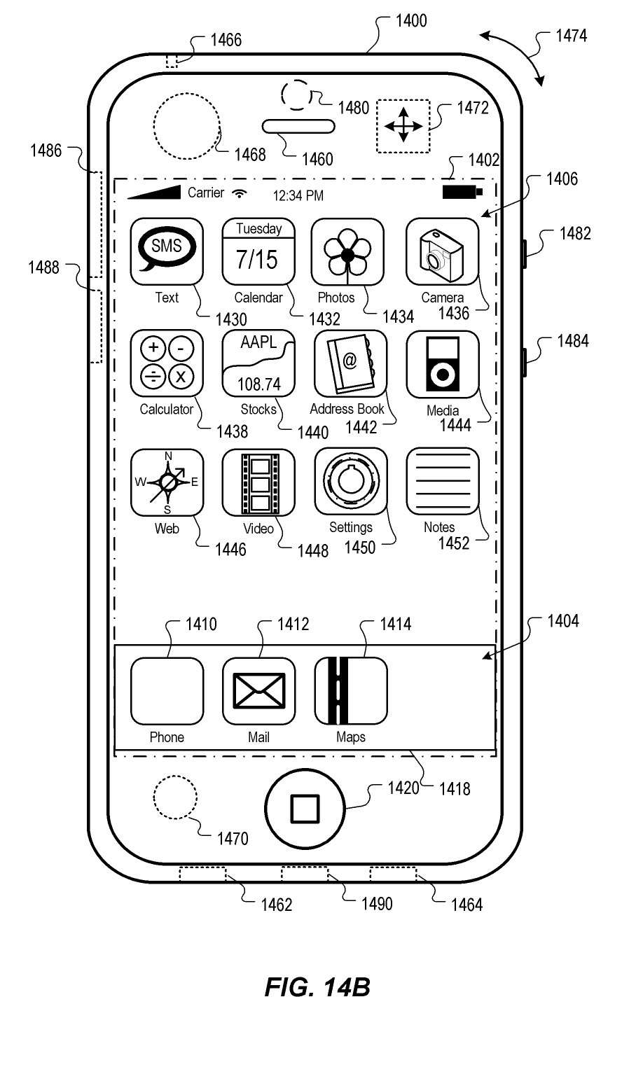

FIG. 14A illustrates an example mobile device 1400. The mobile device 1400 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 1400 includes a touch-sensitive display 1402. The touch-sensitive display 1402 can be implemented with liquid crystal display (LCD) technology, light emitting polymer display (LPD) technology, or some other display technology. The touch sensitive display 1402 can be sensitive to haptic and/or tactile contact with a user.

In some implementations, the touch-sensitive display 1402 can comprise a multi-touch-sensitive display 1402. A multi-touch-sensitive display 1402 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 1400 can display one or more graphical user interfaces on the touch-sensitive display 1402 for providing the user access to various system objects and for conveying information to the user. In some implementations, the graphical user interface can include one or more display objects 1404, 1406. In the example shown, the display objects 1404, 1406, are graphic representations of system objects. Some examples of system objects include device functions, applications, windows, files, alerts, events, or other identifiable system objects.

### Example Mobile Device Functionality

In some implementations, the mobile device 1400 can implement multiple device functionalities, such as a telephony device, as indicated by a Phone object 1410; an e-mail device, as indicated by the Mail object 1412; a map devices, as indicated by the Maps object 1414; a Wi-Fi base station device (not shown); and a network video transmission and display device, as indicated by the Web Video object 1416. In some implementations, particular display objects 1404, e.g., the Phone object 1410, the Mail object 1412, the Maps object 1414, and the Web Video object 1416, can be displayed in a menu bar 1418. In some implementations device functionalities can be accessed from a top-level graphical user interface, such as the graphical user interface illustrated in FIG. 14A. Touching one of the objects 1410, 1412, 1414, or 1416 can, for example, invoke a corresponding functionality.

In some implementations, the mobile device 1400 can implement a network distribution functionality. For example, the functionality can enable the user to take the mobile device 1400 and provide access to its associated network while traveling. In particular, the mobile device 1400 can extend Internet access (e.g., Wi-Fi) to other wireless devices in the vicinity. For example, mobile device 1400 can be configured as a base station for one or more devices. As such, mobile device 1400 can grant or deny network access to other wireless devices.

In some implementations, upon invocation of a device functionality, the graphical user interface of the mobile device 1400 changes, or is augmented or replaced with another user interface or user interface elements, to facilitate user access to particular functions associated with the corresponding device functionality. For example, in response to a user touching the Phone object 1410, the graphical user interface of the touch-sensitive display 1402 may present display objects related to various phone functions; likewise, touching of the Mail object 1412 may cause the graphical user interface to present display objects related to various e-mail functions; touching the Maps object 1414 may cause the graphical user interface to present display objects related to various maps functions; and touching the Web Video object 1416 may cause the graphical user interface to present display objects related to various web video functions.

In some implementations, the top-level graphical user interface environment or state of FIG. 14A can be restored by pressing a button 1420 located near the bottom of the mobile device 1400. In some implementations, each corresponding device functionality may have corresponding “home” display objects displayed on the touch-sensitive display 1402, and the graphical user interface environment of FIG. 14A can be restored by pressing the “home” display object.

In some implementations, the top-level graphical user interface can include additional display objects 1406, such as a short messaging service (SMS) object 1430, a Calendar object 1432, a Photos object 1434, a Camera object 1436, a Calculator object 1438, a Stocks object 1440, a Address Book object 1442, a Media object 1444, a Web object 1446, a Video object 1448, a Settings object 1450, and a Notes object (not shown). Touching the SMS display object 1430 can, for example, invoke an SMS messaging environment and supporting functionality; likewise, each selection of a display object 1432, 1434, 1436, 1438, 1440, 1442, 1444, 1446, 1448, and 1450 can invoke a corresponding object environment and functionality.

Additional and/or different display objects can also be displayed in the graphical user interface of FIG. 14A. For example, if the device 1400 is functioning as a base station for other devices, one or more “connection” objects may appear in the graphical user interface to indicate the connection. In some implementations, the display objects 1406 can be configured by a user, e.g., a user may specify which display objects 1406 are displayed, and/or may download additional applications or other software that provides other functionalities and corresponding display objects.

In some implementations, the mobile device 1400 can include one or more input/output (I/O) devices and/or sensor devices. For example, a speaker 1460 and a microphone 1462 can be included to facilitate voice-enabled functionalities, such as phone and voice mail functions. In some implementations, an up/down button 1484 for volume control of the speaker 1460 and the microphone 1462 can be included. The mobile device 1400 can also include an on/off button 1482 for a ring indicator of incoming phone calls. In some implementations, a loud speaker 1464 can be included to facilitate hands-free voice functionalities, such as speaker phone functions. An audio jack 1466 can also be included for use of headphones and/or a microphone.

In some implementations, a proximity sensor 1468 can be included to facilitate the detection of the user positioning the mobile device 1400 proximate to the user's ear and, in response, to disengage the touch-sensitive display 1402 to prevent accidental function invocations. In some implementations, the touch-sensitive display 1402 can be turned off to conserve additional power when the mobile device 1400 is proximate to the user's ear.

Other sensors can also be used. For example, in some implementations, an ambient light sensor 1470 can be utilized to facilitate adjusting the brightness of the touch-sensitive display 1402. In some implementations, an accelerometer 1472 can be utilized to detect movement of the mobile device 1400, as indicated by the directional arrow 1474. Accordingly, display objects and/or media can be presented according to a detected orientation, e.g., portrait or landscape. In some implementations, the mobile device 1400 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 1400 or provided as a separate device that can be coupled to the mobile device 1400 through an interface (e.g., port device 1490) to provide access to location-based services.

In some implementations, a port device 1490, e.g., a Universal Serial Bus (USB) port, or a docking port, or some other wired port connection, can be included. The port device 1490 can, for example, be utilized to establish a wired connection to other computing devices, such as other communication devices 1400, network access devices, a personal computer, a printer, a display screen, or other processing devices capable of receiving and/or transmitting data. In some implementations, the port device 1490 allows the mobile device 1400 to synchronize with a host device using one or more protocols, such as, for example, the TCP/IP, HTTP, UDP and any other known protocol.

The mobile device 1400 can also include a camera lens and sensor 1480. In some implementations, the camera lens and sensor 1480 can be located on the back surface of the mobile device 1400. The camera can capture still images and/or video.

The mobile device 1400 can also include one or more wireless communication subsystems, such as an 802.11b/g communication device 1486, and/or a Bluetooth™ communication device 1488. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Example Configurable Top-Level Graphical User Interface

FIG. 14B illustrates another example of configurable top-level graphical user interface of device 1400. The device 1400 can be configured to display a different set of display objects.

In some implementations, each of one or more system objects of device 1400 has a set of system object attributes associated with it; and one of the attributes determines whether a display object for the system object will be rendered in the top-level graphical user interface. This attribute can be set by the system automatically, or by a user through certain programs or system functionalities as described below. FIG. 14B shows an example of how the Notes object 1452 (not shown in FIG. 14A) is added to and the Web Video object 1416 is removed from the top graphical user interface of device 1400 (e.g. such as when the attributes of the Notes system object and the Web Video system object are modified).

### Example Mobile Device Architecture

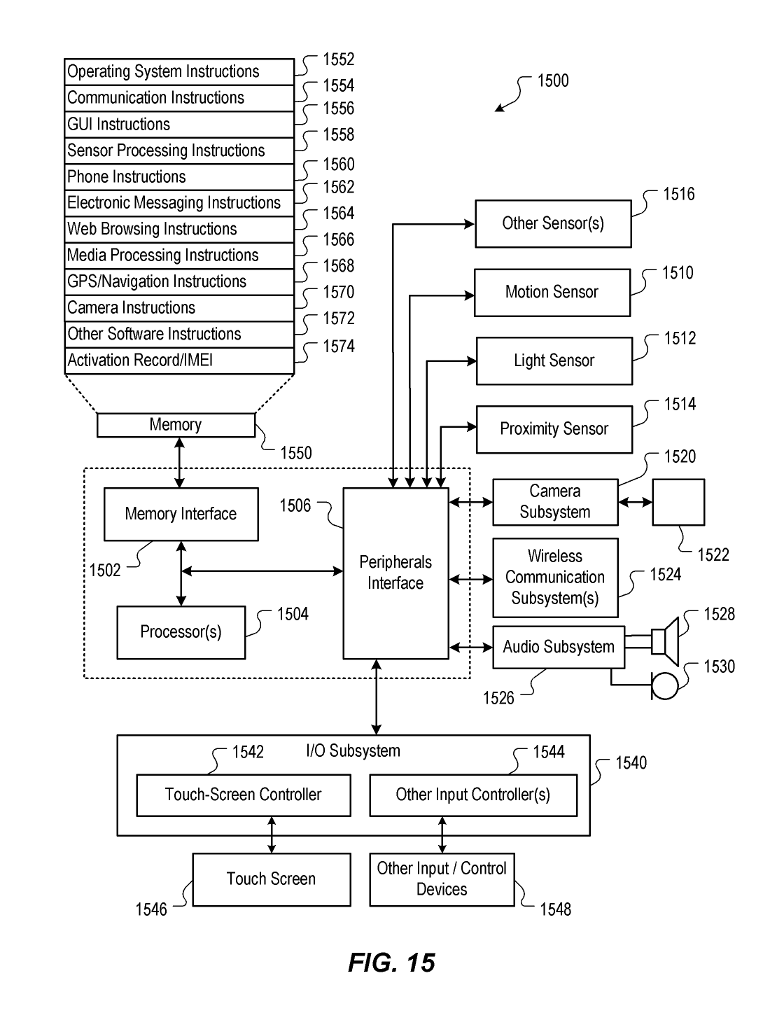

FIG. 15 is a block diagram 1500 of an example implementation of a mobile device (e.g., mobile device 1400). The mobile device can include a memory interface 1502, one or more data processors, image processors and/or central processing units 1504, and a peripherals interface 1506. The memory interface 1502, the one or more processors 1504 and/or the peripherals interface 1506 can be separate components or can be integrated in one or more integrated circuits. The various components in the mobile device can be coupled by one or more communication buses or signal lines.

Sensors, devices, and subsystems can be coupled to the peripherals interface 1506 to facilitate multiple functionalities. For example, a motion sensor 1510, a light sensor 1512, and a proximity sensor 1514 can be coupled to the peripherals interface 1506 to facilitate the orientation, lighting, and proximity functions described with respect to FIG. 14A. Other sensors 1516 can also be connected to the peripherals interface 1506, such as a positioning system (e.g., GPS receiver), a temperature sensor, a biometric sensor, or other sensing device, to facilitate related functionalities.

A camera subsystem 1520 and an optical sensor 1522, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 1524, which can include radio frequency receivers and transmitters and/or optical (e.g., infrared) receivers and transmitters. The specific design and implementation of the communication subsystem 1524 can depend on the communication network(s) over which the mobile device is intended to operate. For example, a mobile device can include communication subsystems 1524 designed to operate over a GSM network, a GPRS network, an EDGE network, a Wi-Fi or WiMax network, and a Bluetooth™ network. In particular, the wireless communication subsystems 1524 may include hosting protocols such that the mobile device may be configured as a base station for other wireless devices.

An audio subsystem 1526 can be coupled to a speaker 1528 and a microphone 1530 to facilitate voice-enabled functions, such as voice recognition, voice replication, digital recording, and telephony functions.

The I/O subsystem 1540 can include a touch screen controller 1542 and/or other input controller(s) 1544. The touch-screen controller 1542 can be coupled to a touch screen 1546. The touch screen 1546 and touch screen controller 1542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 1546.

The other input controller(s) 1544 can be coupled to other input/control devices 1548, such as one or more buttons, rocker switches, thumb-wheel, infrared port, USB port, and/or a pointer device such as a stylus. The one or more buttons (not shown) can include an up/down button for volume control of the speaker 1528 and/or the microphone 1530.

In one implementation, a pressing of the button for a first duration may disengage a lock of the touch screen 1546; and a pressing of the button for a second duration that is longer than the first duration may turn power to the mobile device on or off. The user may be able to customize a functionality of one or more of the buttons. The touch screen 1546 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 1502 can be coupled to memory 1550. The memory 1550 can include high-speed random access memory and/or non-volatile memory, such as one or more magnetic disk storage devices, one or more optical storage devices, and/or flash memory (e.g., NAND, NOR). The memory 1550 can store an operating system 1552, such as Darwin, RTXC, LINUX, UNIX, OS X, WINDOWS, or an embedded operating system such as VxWorks. The operating system 1552 may include instructions for handling basic system services and for performing hardware dependent tasks. In some implementations, the operating system 1552 can be a kernel (e.g., UNIX kernel).

The memory 1550 may also store communication instructions 1554 to facilitate communicating with one or more additional devices, one or more computers and/or one or more servers. The memory 1550 may include graphical user interface instructions 1556 to facilitate graphic user interface processing; sensor processing instructions 1558 to facilitate sensor-related processing and functions; phone instructions 1560 to facilitate phone-related processes and functions; electronic messaging instructions 1562 to facilitate electronic-messaging related processes and functions; web browsing instructions 1564 to facilitate web browsing-related processes and functions; media processing instructions 1566 to facilitate media processing-related processes and functions; GPS/Navigation instructions 1568 to facilitate GPS and navigation-related processes and instructions; camera instructions 1570 to facilitate camera-related processes and functions; and/or other software instructions 1572 to facilitate other processes and functions, e.g., access control management functions. The memory 1550 may also store other software instructions (not shown), such as web video instructions to facilitate web video-related processes and functions; and/or web shopping instructions to facilitate web shopping-related processes and functions. In some implementations, the media processing instructions 1566 are divided into audio processing instructions and video processing instructions to facilitate audio processing-related processes and functions and video processing-related processes and functions, respectively. An activation record and International Mobile Equipment Identity (IMEI) 1574 or similar hardware identifier can also be stored in memory 1550.

Each of the above identified instructions and applications can correspond to a set of instructions for performing one or more functions described above. These instructions need not be implemented as separate software programs, procedures, or modules. The memory 1550 can include additional instructions or fewer instructions. Furthermore, various functions of the mobile device may be implemented in hardware and/or in software, including in one or more signal processing and/or application specific integrated circuits.

It will be understood by those of skill in the art that numerous and various modifications can be made without departing from the spirit of the present invention. Therefore, it should be clearly understood that the forms of the invention are illustrative only and are not intended to limit the scope of the invention. While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention.

What is claimed is:

1. A computer-implemented method of generating a developer access profile, said method comprising:
receiving a developer identifier, a device identifier indicative of a developer computing device, and a requested entitlement related to the developer computing device;
generating entitlement data based at least in part on the requested entitlement;
digitally signing the developer identifier, the device identifier, and the generated entitlement data using a trusted authority private key; and
transmitting the digitally signed data to a developer.

2. The method of claim 1, wherein the entitlement data is indicative of an entitlement to access data on a computing device associated with the device identifier.

3. The method of claim 1, wherein the entitlement data is indicative of an entitlement to access services in an operating system of a computing device associated with the device identifier.

4. The method of claim 1, wherein the developer identifier comprises a developer public key.

5. The method of claim 1, wherein the device identifier comprises a serial number.

6. The method of claim 1, wherein the computing device comprises a mobile telephone handset.

7. The method of claim 1, wherein the digitally signed data comprises the developer access profile.

8. The method of claim 7, wherein the developer access profile is delivered to a mobile telephone device via a software development computing device.

9. A computer-readable medium having computer-executable instructions stored thereon, which when executed on a processor cause a computing device to perform a method of generating a developer access profile, the method comprising:
receiving a developer identifier, a device identifier indicative of a developer computing device, and a requested entitlement related to the developer computing device;
generating entitlement data based at least in part on the requested entitlement;
digitally signing the developer identifier, the device identifier, and the generated entitlement data using a trusted authority private key; and
transmitting the digitally signed data to a developer.

10. A computer-implemented method of providing developer access in an operating environment:
receiving a request for development access to a device from a software developer, the developer access request comprising at least one requested entitlement;
generating an access profile in response to the request, the developer access profile including entitlement data indicative of the requested entitlement; and
delivering the developer access profile to the software developer that is specific to the device and the developer.

11. The method of claim 10, wherein the entitlement data comprises an entitlement white list.

12. The method of claim 10, wherein the entitlement data comprises an entitlement blacklist.

13. The method of claim 10, wherein the entitlement data comprises an entitlement white list and an entitlement blacklist.

14. The method of claim 10, wherein the entitlement data comprises at least one or more of an allow debugging entitlement, an allow trace entitlement, an allow access to address book data entitlement, or allow access to multimedia API entitlement.

15. The method of claim 10, wherein the request for development access is received by a trusted authority.

16. The method of claim 10, wherein the request for development access further includes a public key associated with the software developer.

17. The method of claim 10, wherein the developer access profile comprises at least one device identifier and one developer identifier.

18. The method of claim 17, further comprising installing a policy service on a device related to the at least one device identifier.

19. The method of claim 18, wherein the policy service is configured to allow code to execute on a computer device only if the entitlements are sufficient.

20. A computer-readable medium having computer-executable instructions stored thereon, which when executed on a processor cause a computing device to perform a method of providing developer access in a operating environment, the method comprising:
receiving a request for development access to a device from a software developer, the developer access request comprising at least one requested entitlement;
generating an access profile in response to the request, the developer access profile including entitlement data indicative of the requested entitlement; and
delivering the developer access profile to the software developer that is specific to the device and the developer.

21. A computer-implemented method of authenticating software in a computing device, the method comprising:
receiving a request to execute code, wherein the code requests access to protected system resources;
accessing entitlement data in a developer access profile stored in a memory of the device to determine that the computing device is authorized to allow the code to access the protected system resources of that device and by a developer corresponding to the developer access profile; and
executing the code if the device and the developer is authorized to allow the code to access the protected system resources based on entitlements in the developer access profile.

22. The method of claim 21, wherein accessing the entitlement data is performed by a policy service, and wherein the policy service determines whether to allow execution of the code.

23. The method of claim 22, wherein the policy service runs in user space of memory on the device.

24. The method of claim 21, wherein the code comprises a memory page of a computer software application.

25. The method of claim 21, wherein the code comprises a plurality of pages of a computer software application.

26. The method of claim 21, wherein the developer access profile further comprises device identifier data.

27. The method of claim 26, further comprising accessing the device identifier data to determine that the computing device is authorized to execute the code.

28. The method of claim 27, wherein accessing the device identifier to determine that the computing device is authorized to execute the code comprises comparing a device identifier in the device identifier data of the access profile with a device identifier associated with the computing device.

29. The method of claim 21, wherein the computing device comprises a mobile telephone device.

30. The method of claim 21, wherein an operating system of the mobile device is configured to allow only digitally signed code to execute on the device.

31. A computer-readable medium having computer-executable instructions stored thereon, which when executed on a processor cause a computing device to perform a method of authenticating software in a computing device, the method comprising:
receiving a request to execute code, wherein the code requests access to protected system resources;
accessing entitlement data in a developer access profile stored in a memory of the device to determine that the computing device is authorized to allow the code to access the protected system resources of that device and by a developer corresponding to the developer access profile; and
executing the code if the device and the developer is authorized to allow the code to access the protected system resources based on entitlements in the developer access profile.

32. A method of executing code on a computing device, the method comprising:
receiving a request to execute code on the device, wherein the code requires access to restricted system resources;
retrieving a developer access profile that is specific to the device and a developer of the executing code comprising entitlement data in response to the request;
comparing the retrieved entitlement data to the access required by the code; and
allowing execution of the code based on the comparison.

33. A system for providing software developers an ability to execute software in a restricted operating environment, comprising:
a first computing device configured to generate a developer access profile, the developer access profile comprising data indicative of a device, data indicative of a developer, and data indicative of entitlements;
a second computing device comprising a software development environment configured to compile object code and digitally sign at least some of the compiled object code with a digital certificate associated with the developer; and
a third computing device configured to receive the generated developer access profile, and execute code only if access requested by the code is permitted by the data indicative of entitlements.

34. A mobile telephone device comprising:
a device identifier associated with the mobile telephone device;
software code digitally signed by a digital certificate related to a developer and specific to the device;
at least one developer access profile comprising an entitlement;
at least one policy service configured to process a request to execute the software code by determining that access to system resources on the mobile telephone device is permitted by the entitlement.
